(19) United States
(12) Patent Application Publication
(10) Pub. No.: US 2025/0269401 A1
(43) Pub. Date: Aug. 28, 2025

(54) NOZZLE FOR A SEALER GUN AND A METHOD OF APPLYING SEALER USING THE SAME

(71) Applicants: HYUNDAI MOTOR COMPANY, Seoul (KR); KIA CORPORATION, Seoul (KR)

(72) Inventor: Kyung-Hyun Nam, Hwaseong-si (KR)

(73) Assignees: HYUNDAI MOTOR COMPANY, Seoul (KR); KIA CORPORATION, Seoul (KR)

(21) Appl. No.: 18/959,191

(22) Filed: Nov. 25, 2024

(30) Foreign Application Priority Data
Feb. 23, 2024 (KR) 10-2024-0026618

(51) Int. Cl. B05C 17/005

(52) U.S. Cl. CPC B05C 17/00506

(57) ABSTRACT

A nozzle for a sealer gun to apply a sealer for sealing a device to a panel of a vehicle includes a housing into which an end portion of the sealer gun is inserted and which has a hollow therein, and a core disposed to be spaced by an interval from an inner surface of the housing and having a lower portion exposed downward from the housing, wherein, in a state in which a lower end of the housing is in close contact with a panel, a sealer supplied from the sealer gun to the housing is applied to a surface of the panel between the housing and the core.

### CROSS-REFERENCE TO RELATED APPLICATION

This application claims priority to Korean Patent Application No. 10-2024-0026618, filed on Feb. 23, 2024, which is incorporated herein by reference in its entirety.

### BACKGROUND

### Field

The present disclosure relates to a nozzle for a sealer gun and a method of applying sealer using the same to seal a device to a panel of a vehicle.

### Description of Related Art

In vehicles, such as buses and trucks, an additional device like an air conditioner or the like is attached onto an exterior portion of the vehicle, such as a roof.

In general, the device is attached on the roof usually using bolts and nuts. For example, to attach the device to the roof of the vehicle, as shown in FIG. 1, a sealer or a sealant for watertightness is applied to a circumference of a through hole 111 formed in a roof panel 110 using a tool, such as a sealer gun 120.

Thereafter, a bracket 115 on which the device is attached is fixed to the roof panel 110 using a fastening bolt 116 and a fastening nut 117 (see FIG. 2) so that the device is mounted on the roof panel 110.

When the sealer 130 is applied to the circumference of the through hole 111 using the sealer gun 120, the sealer 130 should be uniformly and continuously applied to the circumference of the through hole 111 for watertightness. However, when the sealer 130 is applied manually, it would be difficult to continuously apply the sealer 130 around the through hole 111. Alternatively, although it is possible to secure watertightness performance by excessively applying the sealer 130, this leads to unnecessary sealer consumption (i.e., increasing an amount of wasted sealer) and higher production costs. Moreover, the sealer 130 exposed outside the through hole 111 after the device is attached impairs an outer appearance of the vehicle, and a foreign substance, such as dust or minute particles, tends to accumulate on or around the exposed sealer 130.

Meanwhile, another sealing work may be performed using a rubber spacer or a washer 118 instead of the sealer 130, but in some portions, the rubber spacer or the washer 118 tears due to fatigue in the process of fastening the fastening bolt 116 (see FIG. 3), causing a problem of not being watertight (i.e., water leakage) around the through hole 111.

In other words, the rubber spacer or the washer 118 may be applied to a portion marked by a dot- and dash line (a) or (b) in FIG. 2, and in the portion marked by (a), it is possible to prevent a moisture penetration through a path marked by an arrow (1) by a vertical force acting between the roof panel 110 and the bracket 115. However, the portion marked by (b) is torn in the process of tightening the fastening bolt 116, and thus moisture may permeate through a path marked by an arrow (2). A probability of tearing of the rubber spacer and the washer 118 or a degree of damage to the rubber spacer and the washer 118 increases as fastening and unfastening works of the fastening bolt 116 are repeated to adjust a height or a step difference or the like while the device is mounted on the roof.

The statements in this Background section merely provide background information related to the present disclosure and may not constitute prior art.

### SUMMARY

The present disclosure is directed to providing a nozzle for a sealer gun for allowing an appropriate amount of sealer to be continuously and easily applied to a through hole formed in a panel, and a method of applying the sealer using the same.

According to an embodiment of the present disclosure, a nozzle for a sealer gun may include: a hollow housing into which a lower end portion of the sealer gun is inserted, and a core disposed to be spaced apart from an inner surface of the housing and having a lower portion exposed downward from the housing. In particular, in a state in which a bottom end of the housing is in close contact with a panel, a sealer supplied from the sealer gun to the housing is applied to a surface of the panel between the housing and the core.

The core may include a support portion connecting the inner surface of the housing with an outer surface of the core, and the support portion is formed at an interval along a circumference of the core. The core may further include a spiral portion formed under the support portion in a spiral shape.

A bottom end of the support portion may be formed to be positioned higher than a bottom end of the housing by a predetermined height.

An inner diameter of the housing may be greater than a diameter of a through hole formed in the panel.

When the bottom end of the housing is in close contact with the panel, the core may be positioned lower than a bottom end of a fastening nut coupled to a bottom surface of the panel.

A top end of the core may be positioned lower than a top end of the housing by a predetermined height.

The sealer gun may be inserted between the top end of the housing and the top end of the core in the housing.

In another embodiment, a method of applying a sealer using a nozzle for a sealer gun may include: a nozzle seating operation of positioning a core within a through hole formed in a panel and seating the nozzle on the panel so that a bottom surface of a housing of the nozzle is in close contact with the panel; a sealer injecting operation of injecting the sealer from the sealer gun into the housing, and a nozzle separating operation of separating the nozzle from the panel after injecting the sealer.

The nozzle seating operation may include seating the nozzle on the panel in a state in which the sealer gun is connected to the housing.

The method may further include a sealer gun connecting operation of connecting the sealer gun with the housing between the nozzle seating operation and the sealer injecting operation.

According to another exemplary embodiment of the present disclosure, a nozzle for a sealer gun may include: a housing into which an end portion of the sealer gun is inserted; and a core disposed within the housing to make a space between the core and the housing. The core is configured to allow a sealer supplied from the sealer gun to flow down through the space such that the sealer is applied to a panel onto which a device for a vehicle is attached.

The core may include at least one support portion connecting an inner surface of the housing with an outer surface of the core; and a spiral portion formed in a spiral shape and disposed under the at least one support portion in the core.

The at least one support portion may be formed at an interval along the circumference of the core.

The at least one support portion includes three support portions, and the three support portions are formed in three locations and spaced 120 degrees apart along the circumference of the core.

A bottom end of the at least one support portion is formed to be positioned higher than the bottom end of the housing by a predetermined height.

An inner diameter of the housing is greater than a diameter of a through hole formed in the panel.

when the bottom end of the housing is in close contact with the panel, the core is positioned lower than a bottom end of a fastening nut coupled to a bottom surface of the panel.

A gap is formed between the bottom end of the at least one support portion and the upper surface of the panel.

A top end of the core is positioned to be lower than the top end of the housing by a predetermined height.

The sealer gun is inserted between the top end of the housing and the top end of the core in the housing.

According to the nozzle for the sealer gun according to the present disclosure having the above configuration and the method of applying the sealer using the same, it is possible to continuously and easily apply the sealer to a portion in which a device is to be mounted on the panel.

Therefore, it would be noted that time required to apply the sealer may be reduced, an appropriate amount of sealer may be applied, and the sealer may be applied regardless of a proficiency in workmanship.

In addition, in the process of separating the nozzle for the sealer gun, the sealer may be evenly applied to an inner surface of the fastening nut coupled to the panel, thereby providing a uniform and perfect watertightness performance at a mounted portion of the device.

In addition, since the sealer covers a portion in which the fastening bolt and the fastening nut are fastened, rust prevention performance may be expected, and since a frictional force is decreased by the sealer before the sealer is cured when the fastening bolt is fastened, it is possible to increase a fastening torque, and after the sealer is cured, the sealer increases a fastening force of the fastening bolt.

### BRIEF DESCRIPTION OF THE DRAWINGS

FIG. 1 is a perspective view illustrating a process of manually applying a sealer to a roof panel according to the related art.

FIG. 2 is a cross-sectional view illustrating a state in which a device is mounted on the roof panel according to the related art.

FIG. 3 is a perspective view illustrating a state in which a washer is torn according to the related art.

FIG. 4 is a perspective view illustrating a nozzle for a sealer gun according to an embodiment of the present disclosure.

FIG. 5 is a partially cutout perspective view illustrating a state in which the nozzle for the sealer gun is coupled with the roof panel, according to an embodiment of the present disclosure.

FIG. 6 is a partially cutout side view illustrating a portion of the nozzle for the sealer gun according to an embodiment of the present disclosure.

FIG. 7 is a cross-sectional view along line I-I in FIG. 6.

FIG. 8 is a cross-sectional view along line II-II in FIG. 6.

FIG. 9 is a cross-sectional view along line III-III in FIG. 6.

FIG. 10 is a schematic partially cutout perspective view illustrating an initial state in a process in which a sealer is applied through the nozzle for the sealer gun according to an embodiment of the present disclosure.

FIG. 11 is a schematic partially cutout perspective view illustrating a state in which the sealer is applied near a through hole of the roof panel as shown by an arrow through the nozzle for the sealer gun according to an embodiment of the present disclosure.

FIG. 12 is a schematic a partially cutout perspective view illustrating a state in which the nozzle for the sealer gun according to the present disclosure is separated from the through hole of the roof panel after applying the sealer.

FIG. 13 is a schematic partially cutout perspective view illustrating an intermediate state in which the sealer supplied from the nozzle for the sealer gun according to the present disclosure is being applied to an inner surface of a fastening nut.

FIG. 14 is a schematic partially cutout perspective view illustrating a final state in which the sealer supplied from the nozzle for the sealer gun according to the present disclosure is applied to a fastening hole and the fastening nut.

FIG. 15 is a flowchart illustrating a method of applying a sealer according to an embodiment of the present disclosure.

FIG. 16 is a flowchart illustrating a method of applying a sealer according to another embodiment of the present disclosure.

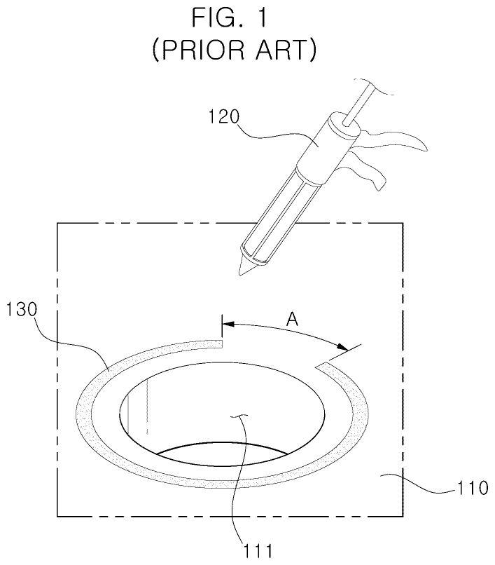

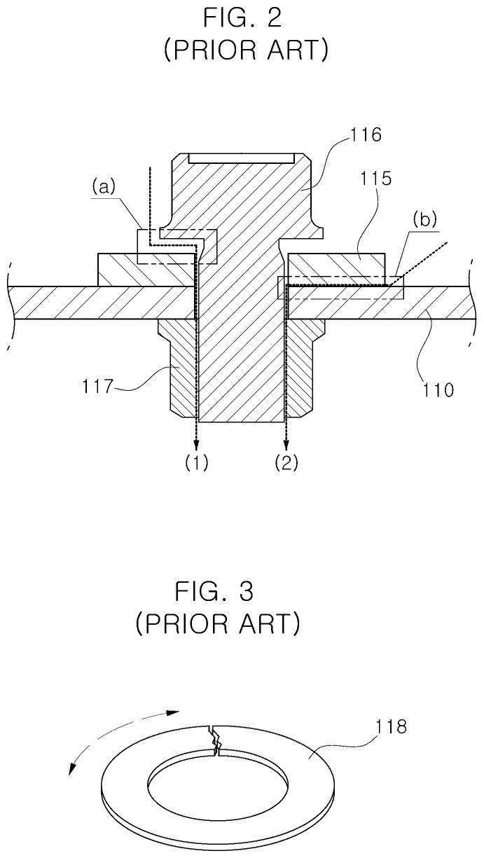

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

When a component, device, element, or the like of the present disclosure is described as having a purpose or performing an operation, function, or the like, the component, device, or element should be considered herein as being “configured to” meet that purpose or to perform that operation or function.

Hereinafter, a nozzle for a sealer gun according to an embodiment of the present disclosure and a method of applying a sealer using the same are described in detail with reference to the accompanying drawings.

In one embodiment, a nozzle 20 for a sealer gun 40 may include: a hollow housing 21 into which an end portion of the sealer gun is inserted, and a core 22 disposed to be spaced apart from an inner surface 21a of the housing 21 and having a lower portion exposed downward from the housing 21. In a state where a lower end (i.e., a bottom end) of the housing 21 is in close contact with a panel 10, a sealer 30 supplied to the housing 21 from the sealer gun 40 is applied to a surface of the panel 10 between the housing 21 and the core 22.

The housing 21 may be formed in a hollow cylindrical structure. An upper portion of the housing 21 may be connected to a lower end of the sealer gun 40, and the lower end of the housing 21 may be in contact with the panel 10 on which a device (e.g., an air conditioner) is mounted.

An end portion of the sealer gun 40 may be inserted into the upper portion of the housing 21 so that the sealer 30 supplied from the sealer gun 40 is applied to the panel 10 through an internal space of the housing 21.

The lower end of the housing 21 may be in close contact with the panel 10 on which the device is mounted, such as a roof panel for a vehicle. As the lower end of the housing 21 is in close contact with the panel 10, the sealer 30 may be applied to the internal space in which watertightness is required and is prevented from spreading to a periphery of the housing 21.

An inner diameter of the housing 21 may be formed to be greater than a diameter of a through hole 11 formed in the panel 10. As the inner diameter of the housing 21 is formed to be greater than the diameter of the through hole 11, the sealer 30 may flow down and be applied to a circumference of the through hole 11 on an upper surface of the panel 10.

The core 22 may be formed inside the housing 21. An outer surface of the core 22 may be spaced at an interval within the housing 21 such that the sealer 30 injected through the internal space formed between the housing 21 and the core 22 may be applied to the panel 10. Since the through hole 11 is formed in the panel 10 to mount the device, the sealer 30 should be applied to the circumference of the through hole 11 excluding the through hole 11 itself, and thus the core 22 may be positioned at a center of the housing 21.

An upper end (i.e., a top end) of the core 22 may be positioned to be lower than an upper end (i.e., a top end) of the housing 21 by a predetermined height. Therefore, the lower end of the sealer gun 40 may be inserted into a space between the upper end of the housing 21 and the upper end of the core 22 in the housing 21.

When the lower end of the housing 21 is in close contact with the panel 10, the core 22 may be positioned to be lower than a lower end (i.e., a bottom end) of the fastening nut 17, which is fastened to a bottom surface of the panel 10, so that the sealer 30 is also easily applied to the inner surface of the fastening nut 17.

The core 22 may include a support portion 22a that allows the core 22 to be firmly installed inside the housing 21, and a spiral portion 22b formed under the support portion 22a in the core 22.

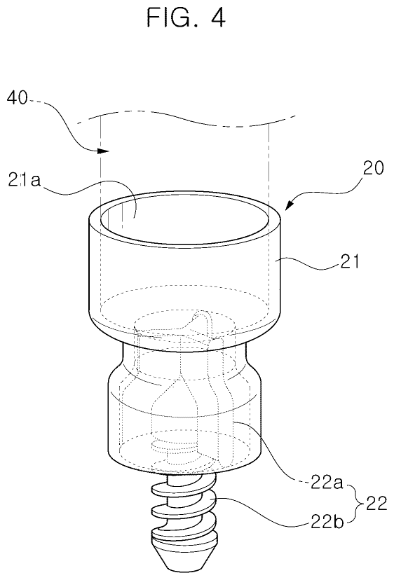

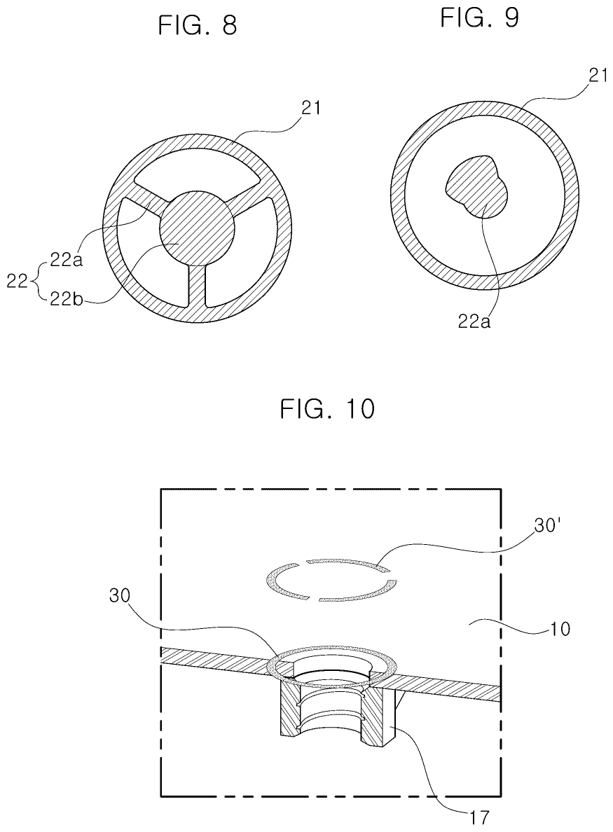

The support portion 22a may connect the inner surface 21a of the housing 21 and an outer surface 22c of the core 22. A plurality of supports portions 22a may be formed along a circumference of the core 22 so that the core 22 is positioned at the center of the housing 21. The support portion 22a may form a space with another adjacent support portion 22a, and the space may become a passage through which the sealer 30 injected into the housing 21 flows downward. FIGS. 4 and 8 show an example in which three support portions 22a are formed at intervals of 120 degrees. In other words, the support portions 22a are formed in three locations, spaced 120 degrees apart along the circumference of the core.

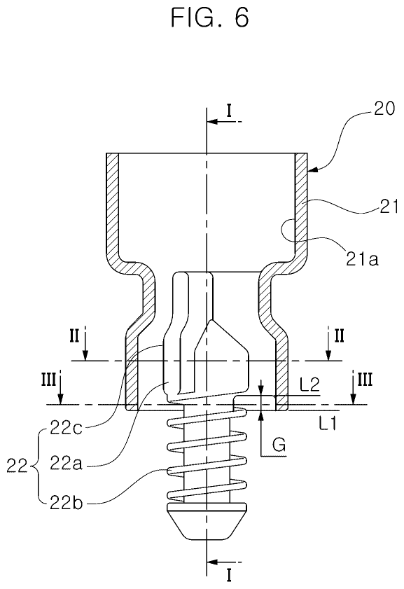

A lower end (i.e., a bottom end) of the support portion 22a is formed to be positioned higher than the lower end (i.e., the bottom end) of the housing 21 by a predetermined height. In other words, in FIG. 6, the lower end of the housing 21 may be indicated with a line L1, and the lower end of the support portion 22a may be indicated with a line L2. This is to ensure that the sealer 30 may be applied continuously on the upper surface of the panel 10 by forming a gap G between the lower end of the support portion 22a and the upper surface of the panel 10. When the lower end of the support portion 22a is positioned at the same height as the lower end of the housing 21, the sealer 30 may not be applied to a portion in which the support portion 22a is formed, such that the sealer 30 is not continuously applied thereto. However, by positioning the lower end of the support portion 22a to be higher than the lower end of the housing 21, the sealer 30 may be continuously applied to the upper surface of the panel 10.

The spiral portion 22b may be formed under the support portion 22a in the core 22. An outer diameter of the spiral portion 22b may be formed to be smaller than an inner diameter of the fastening nut 17 so that a gap between the fastening nut 17 and the spiral portion 22b is formed, and thus the sealer 30 flows downward.

Since the lower portion of the core 22, i.e., the spiral portion 22b is formed to be exposed downward from the housing 21, the sealer 30 injected into the housing 21 may be also easily and continuously applied to the inner surface of the fastening nut 17 fastened to the panel 10.

In addition, since the circumference of the spiral portion 22b is formed in a spiral shape, the sealer 30 may be applied to the inner surface of the fastening nut 17 while flowing spirally. Therefore, when the sealer 30 flows between the fastening nut 17 and the spiral portion 22b, the sealer 30 may spirally flows along the spiral portion 22b, and thus the sealer 30 may be evenly applied due to an increase in a distance between the sealer 30 and the fastening nut 17. In particular, when the nozzle 20 is separated from the panel 10, the spiral portion 22b may linearly move in an axial direction thereof, and thus a circumference of the spiral portion 22b may press the sealer 30 applied toward the inner surface of the fastening nut 17. As a result, the sealer 30 may be applied more evenly onto the inner surface of the fastening nut 17.

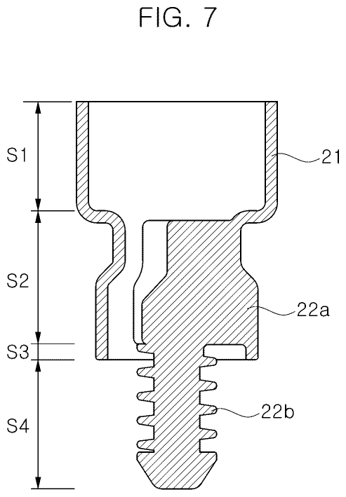

FIG. 7 shows a cross-sectional view of the nozzle 20 for the sealer gun 40.

Since only the housing 21 is formed at a predetermined distance from the upper end of the nozzle 20 for the sealer gun 40 and the core 22 is not formed at such a portion, the nozzle 20 may be firmly connected to the lower end of the sealer gun 40 through such the portion. In other words, in FIG. 7, a section marked by S1 may be a section in which a tip, i.e., the lower end of the sealer gun is inserted into the housing 21 so that the nozzle 20 and the sealer gun are connected.

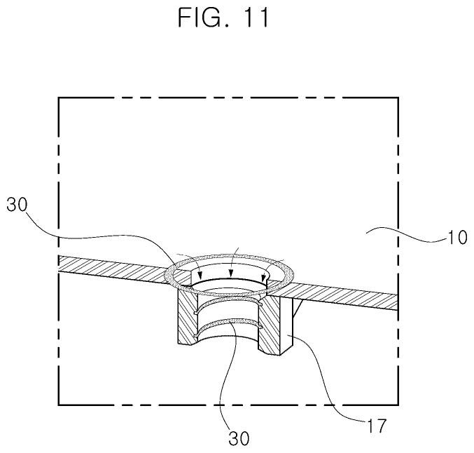

The next section, a section S2, may be a section in which the sealer 30 injected from the sealer gun to the nozzle 20 flows. Since the core 22 is supported by the support portion 22a in the section S2, the sealer 30 flowing in this section may have a discontinuous shape, not a ring shape, in a circumferential direction of the nozzle 20 as exemplarily shown by a reference number 30′ in FIG. 10.

In one form, a section S3 may be a section in which the housing 21 is in contact with the upper surface of the panel 10. In the section S3, the support portion 22a may not be formed, and the sealer 30 may have a continuous shape, i.e., a ring shape, in the circumferential direction of the nozzle 20 as shown at the bottom of FIG. 10.

In addition, a section S4 may be a section from the lower end of the housing 21 to the lower end of the core 22, and in this section, the spiral portion 22b of the core 22 may be exposed downward from the housing 21.

A method of applying a sealer using a nozzle for a sealer gun according to one embodiment of the present disclosure is described as follows.

According to an embodiment of the present disclosure, as shown in FIG. 15, the method of applying the sealer 30 using the nozzle 20 for the sealer gun 40 may include: a nozzle seating operation (an operation S110) of positioning the core 22 inside the through hole 11 in the panel 10 in which the through hole 11 is formed and seating the nozzle 20 on the panel 10 so that the bottom surface of the housing 21 is in close contact with the panel 10; a sealer injecting operation (an operation S130) of injecting the sealer 30 into the housing 21 from the sealer gun; and a nozzle separating operation (an operation S140) of separating the nozzle 20 from the panel 10 after injecting the sealer 30.

In the nozzle seating operation (in the operation S110), the core 22 may be positioned inside the through hole 11 in the panel 10 in which the through hole 11 is formed, and the nozzle 20 may be seated on the panel 10 so that the bottom surface of the housing 21 is in close contact with the panel 10. To additionally mount a device on the panel 10 that forms the appearance of the vehicle, such as a roof panel, the through hole 11 may be formed in the portion of the panel 10 in which the device is mounted. The nozzle 20 may be seated in the through hole 11. In the nozzle 20, the bottom surface of the housing 21 may be brought into close contact with the upper surface of the panel 10, and the core 22 may be positioned at the center of the through hole 11.

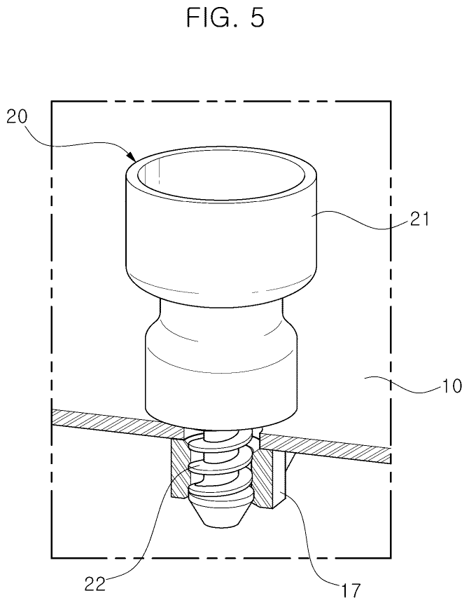

FIG. 5 shows a state in which the nozzle 20 is seated on the panel 10.

In the sealer injection operation (the operation S130), the sealer 30 may be injected from the sealer gun into the housing 21. When a predetermined amount of the sealer 30 is injected from the sealer gun into the housing 21, the sealer 30 may flow downward from the upper end of the housing 21 to the lower end of the core 22 through the internal space formed between the housing 21 and the core 22.

It would be noted that the sealer 30 may continuously flow downward within the housing 21. Here, the sealer 30 may flow down in a discontinuous shape along the circumference of the housing 21 due to the support portion 22a, particularly, while passing through a specific portion such as a middle portion and a lower end portion of the housing 21 as shown in FIG. 10. However, since the support portion 22a is not formed at the lower end of the housing 21, the sealer 30 may flow in a continuous shape along the circumference of the housing 21. Therefore, the sealer 30 may be applied continuously and evenly to the upper surface of the panel 10.

Thereafter, when the sealer 30 is continuously injected, the sealer 30 may pass through the through hole 11 and flow to the inner surface of the fastening nut 17. In other words, the sealer 30 may flow to the inner surface of the fastening nut 17 in a direction marked by an arrow in FIG. 11.

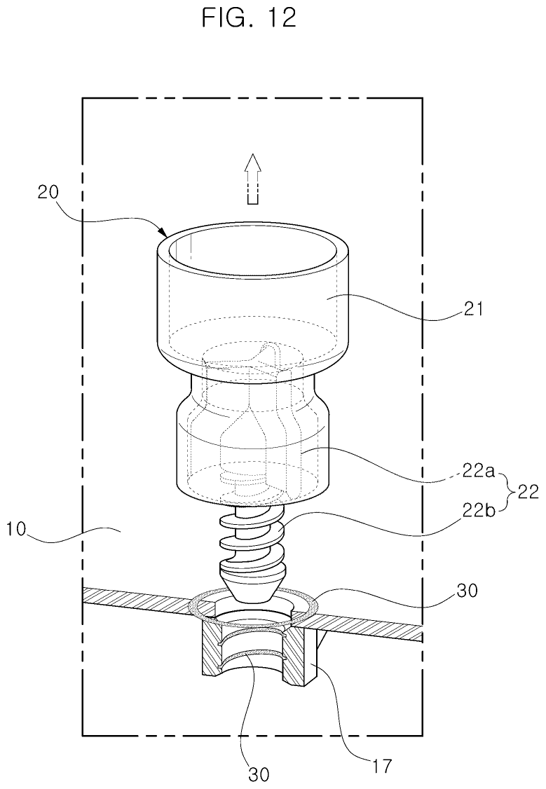

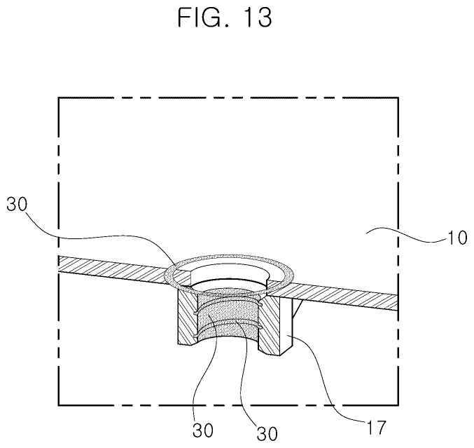

In the nozzle separating operation (the operation S140), the nozzle 20 may be separated from the panel 10 after injecting the sealer 30. The sealer 30 may be applied to the circumference of the through hole 11 on the upper surface of the panel 10, and when the application of the sealer 30 to the inner surface of the fastening nut 17 is finished, the nozzle 20 may be separated from the panel 10. When the nozzle 20 is separated from the panel 10 in the axial direction of the nozzle 20 (see FIG. 12), while the nozzle 20 is separated, an outer surface of the spiral portion 22b may press the sealer 30 being applied toward the inner surface of the fastening nut 17, and thus the sealer 30 may be evenly applied to the inner surface of the fastening nut 17 (see FIG. 13).

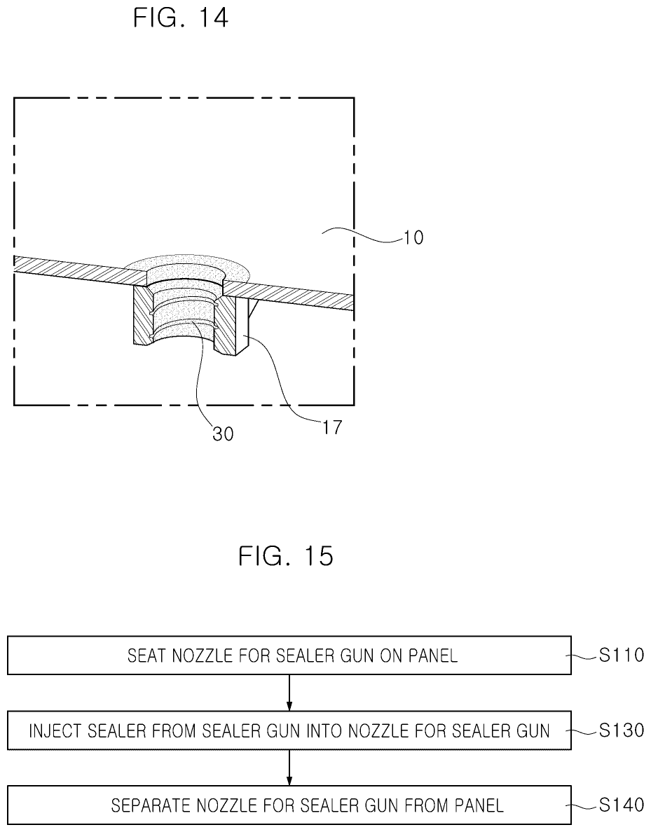

When the nozzle 20 is separated from the panel 10, the sealer 30 may be applied to the circumference of the through hole 11 and the inner surface of the fastening nut 17 on the upper surface of the panel 10. In other words, while the spiral portion 22b is separated from the fastening nut 17 and the through hole 11, the sealer 30 remaining inside the spiral portion 22b may be evenly applied to the through hole 11 and the upper portion of the fastening nut 17. FIG. 14 shows a state in which the sealer 30 is applied finally to the inner surface of the fastening nut 17.

As described above, when the sealer 30 is applied to the circumference of the through hole 11 of the panel 10 and the inner surface of the fastening nut 17, the device may be attached or mounted before the sealer 30 is cured. In other words, in a state in which a bracket (not shown) on which the device is installed is seated in the through hole 11, the fastening bolt (not shown) may pass through the bracket and the panel 10 and may be fastened to the fastening nut 17. As a fastening work of the device is completed before the sealer 30 is cured, it is possible to achieve a secure watertightness in the through hole 11 and the fastening nut 17. In this case, during a fastening work with the fastening bolt, the sealer applied to a thread portion of the fastening nut 17 may come out when the fastening bolt is fastened to fill a portion in which the sealer 30 is insufficiently or not continuously applied, thereby achieving a complete watertightness thereto.

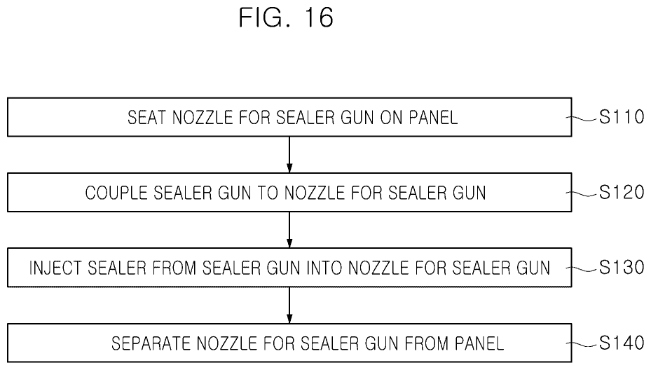

FIG. 16 shows a method of applying a sealer using a nozzle for a sealer gun according to another embodiment of the present disclosure.

The method of applying the sealer using the nozzle for the sealer gun according to the present embodiment includes the configuration of the above-described embodiment.

However, in the present embodiment, a sealer gun connecting operation (an operation S120) may be performed between the nozzle seating operation (the operation S110) and the sealer injecting operation (the operation S130) in FIG. 15.

While the nozzle 20 may be seated on the panel 10 in a state in which the nozzle 20 is coupled to the sealer gun 40, the nozzle 20 is not coupled to the sealer gun 40 and the nozzle 20 is seated on the panel 10 in advance, and in a state in which the sealer gun 40 is seated on the panel 10, the sealer gun 40 may be then connected to the nozzle 20.

When, in the state in which the nozzle is not coupled to the sealer gun 40, the nozzle 20 may be seated on the panel 10 through the nozzle seating operation (the operation S110), in the sealer gun connecting operation (the operation S120), the sealer gun 40 may be inserted into the nozzle 20 so that the nozzle 20 is connected to the sealer gun.

After the sealer gun is connected to the nozzle 20, the sealer injecting operation (the operation S130) and the nozzle separating operation (the operation S140) may be performed.

What is claimed is:

1. A nozzle for a sealer gun, comprising:
a hollow housing into which an end portion of the sealer gun is inserted; and
a core disposed to be spaced apart from an inner surface of the housing and having a portion exposed downward from the housing,
wherein, in a state where a bottom end of the housing is in close contact with a panel, a sealer supplied from the sealer gun to the housing is applied to a surface of the panel between the housing and the core.

2. The nozzle of claim 1, wherein the core includes:
a support portion connecting the inner surface of the housing with an outer surface of the core, wherein the support portion is formed at an interval along a circumference of the core; and
a spiral portion formed under the support portion in a spiral shape.

3. The nozzle of claim 2, wherein a bottom end of the support portion is positioned higher than the bottom end of the housing by a predetermined height.

4. The nozzle of claim 2, wherein an inner diameter of the housing is greater than a diameter of a through hole formed in the panel.

5. The nozzle of claim 2, wherein, when the bottom end of the housing is in close contact with the panel, the core is positioned lower than a bottom end of a fastening nut coupled to a bottom surface of the panel.

6. The nozzle of claim 1, wherein a top end of the core is positioned to be lower than a top end of the housing by a predetermined height.

7. The nozzle of claim 2, wherein the sealer gun is inserted between a top end of the housing and a top end of the core in the housing.

8. A method of applying a sealer using a nozzle for a sealer gun, comprising:
a nozzle seating operation of positioning a core within a through hole formed in a panel and seating the nozzle on the panel so that a bottom surface of a housing of the nozzle is in close contact with the panel;
a sealer injecting operation of injecting the sealer from the sealer gun into the housing; and
a nozzle separating operation of separating the nozzle from the panel after injecting the sealer.

9. The method of claim 8, wherein the nozzle seating operation includes seating the nozzle on the panel in a state in which the sealer gun is connected to the housing.

10. The method of claim 8, further comprising a sealer gun connecting operation of connecting the sealer gun with the housing between the nozzle seating operation and the sealer injecting operation.

11. A nozzle for a sealer gun, comprising:
a housing into which an end portion of the sealer gun is inserted; and
a core disposed inside the housing and configured to form a space between the core and the housing,
wherein the core is configured to allow a sealer supplied from the sealer gun to flow down through the space such that the sealer is applied to a panel onto which a device for a vehicle is attached.

12. The nozzle of claim 11, wherein the core includes:
at least one support portion connecting an inner surface of the housing with an outer surface of the core; and
a spiral portion formed in a spiral shape and disposed under the at least one support portion.

13. The nozzle of claim 12, wherein the at least one support portion is formed at an interval along a circumference of the core.

14. The nozzle of claim 13, wherein the at least one support portion includes three support portions, and the three support portions are formed in three locations and spaced 120 degrees apart along the circumference of the core.

15. The nozzle of claim 13, wherein a bottom end of the at least one support portion is formed to be positioned higher than a bottom end of the housing by a predetermined height.

16. The nozzle of claim 13, wherein an inner diameter of the housing is greater than a diameter of a through hole formed in the panel.

17. The nozzle of claim 16, wherein, when a bottom end of the housing is in close contact with the panel, the core is positioned lower than a bottom end of a fastening nut coupled to a bottom surface of the panel.

18. The nozzle of claim 17, wherein a gap is formed between the bottom end of the at least one support portion and an upper surface of the panel.

19. The nozzle of claim 14, wherein a top end of the core is positioned to be lower than a top end of the housing by a predetermined height.

20. The nozzle of claim 19, wherein the sealer gun is inserted between the top end of the housing and the top end of the core in the housing.
